(19) United States
(12) Patent Application Publication
(10) Pub. No.: US 2019/0026930 A1
(43) Pub. Date: Jan. 24, 2019

(54) DIGITAL INFORMATION RETRIEVAL AND RENDERING IN A FACTORY ENVIRONMENT

(71) Applicant: Siemens Aktiengesellschaft, Munich (DE)

(72) Inventors: Mareike Kritzler, San Francisco, CA (US); Simon Mayer, Berkeley, CA (US)

(21) Appl. No.: 15/657,544

(22) Filed: Jul. 24, 2017

(51) Int. Cl. G06T 11/60; G06F 21/62; G06F 17/30; G06F 3/01; G06K 9/00; G02B 27/01

(52) U.S. Cl. CPC G06T 11/60; G06F 21/62; G06F 17/30256; G02B 2027/014; G06K 9/00671; G02B 27/0172; G02B 2027/0141; G06F 3/017

(57) ABSTRACT

Systems, methods, and computer-readable media are disclosed for utilizing computer-mediated-reality-based technologies such as augmented reality or mixed reality to render digital information about a physical machine or associated process on top of or otherwise in proximity to the machine. The digital information may be rendered as an overlay over the real-world environment. The digital information may be rendered on a display of a wearable device of an operator, such as when the wearable device is within a line-of-sight of the machine, or may be projected onto a surface that is in proximity to the machine. The digital information may also be rendered within a control room environment as an overlay over an actual image or virtual representation of a factory floor environment that includes the machine.

### BACKGROUND

The operation, maintenance, and repair of machinery in today's modern factories results in a large amount of digital data and information being generated and stored across multiple information systems. If information about a machine, a process, a collection of machines involved in a process, or the like is desired, the relevant information is identified, retrieved, and rendered for use by an operator. Machine/process-specific information may be stored in different information systems, at least some of which may be remotely located from a factory environment. Depending on the level of integration between these different systems, an operator may be required to utilize multiple different software applications to access multiple systems to obtain the desired information. This information retrieval process from multiple disparate systems is time-consuming and error-prone, potentially leading to a mismatch between a physical machine or process and the data that is retrieved. Technical solutions that address these and other drawbacks associated are discussed herein.

### BRIEF DESCRIPTION OF THE DRAWINGS

The detailed description is set forth with reference to the accompanying drawings. The drawings are provided for purposes of illustration only and merely depict example embodiments of the disclosure. The drawings are provided to facilitate understanding of the disclosure and shall not be deemed to limit the breadth, scope, or applicability of the disclosure. In the drawings, the left-most digit(s) of a reference numeral identifies the drawing in which the reference numeral first appears. The use of the same reference numerals indicates similar, but not necessarily the same or identical components. However, different reference numerals may be used to identify similar components as well. Various embodiments may utilize elements or components other than those illustrated in the drawings, and some elements and/or components may not be present in various embodiments. The use of singular terminology to describe a component or element may, depending on the context, encompass a plural number of such components or elements and vice versa.

FIG. 1A is a schematic diagram illustrating the use of a computer-mediated-reality-based technology to render digital information relating to a machine or a process involving the machine as an overlay on a display of a wearable device in accordance with one or more example embodiments of the disclosure.

FIG. 1B is a schematic diagram illustrating the use of a computer-mediated-reality-based technology to render digital information relating to a machine or a process involving the machine as a projection on top of or otherwise in proximity to the machine in accordance with one or more example embodiments of the disclosure.

FIG. 2 is a hybrid system component/data flow diagram illustrating the generation and rendering of a digital representation of information relating to a machine or a process involving the machine using a computer-mediated-reality-based technology in accordance with one or more example embodiments of the disclosure.

FIG. 3 is a process flow diagram of an illustrative method for generating and rendering a digital representation of information relating to a machine or a process involving the machine using a computer-mediated-reality-based technology in accordance with one or more example embodiments of the disclosure.

FIG. 4 is a process flow diagram of an illustrative method for prioritizing information relating to a machine or a process involving the machine and rendering a digital representation of the information that reflects the prioritization in accordance with one or more example embodiments of the disclosure.

FIG. 5 is a schematic diagram of an illustrative networked architecture in accordance with one or more example embodiments of the disclosure.

### DETAILED DESCRIPTION

This disclosure relates to, among other things, devices, servers, systems, methods, computer-readable media, techniques, and methodologies for retrieving information relating to a machine or a process involving the machine, generating a digital representation of the retrieved information, and rendering the digital representation within a factory environment on top of or otherwise in proximity to the machine using a computer-mediated-reality-based technology. Computer-mediated-reality-based technologies that may be used include, without limitation, virtual reality technologies, augmented reality technologies, mixed reality technologies, or the like.

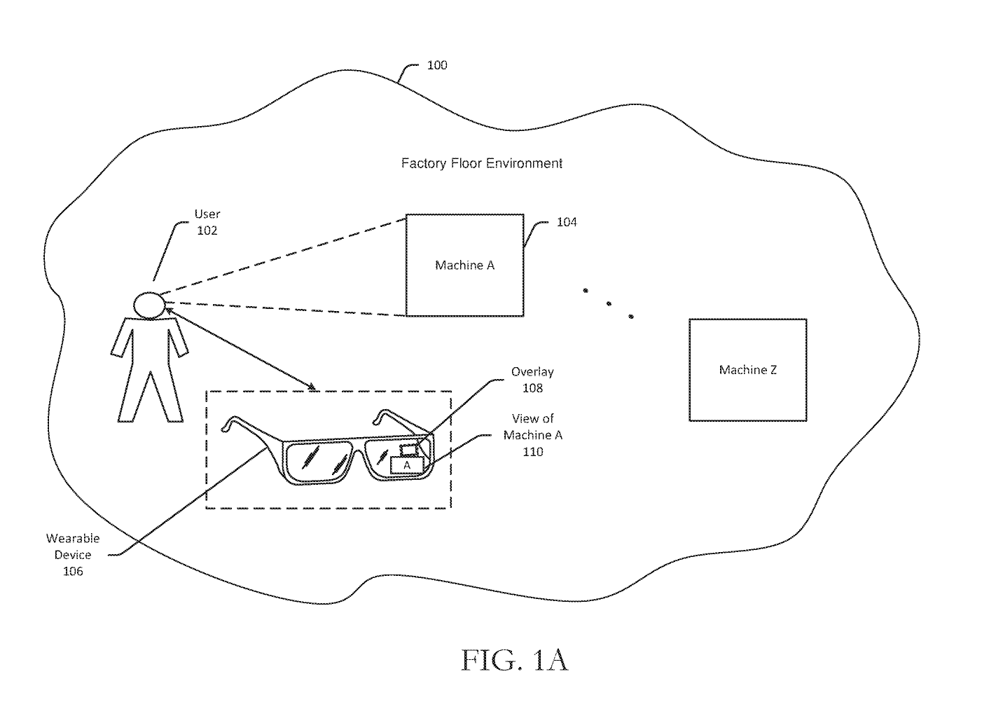

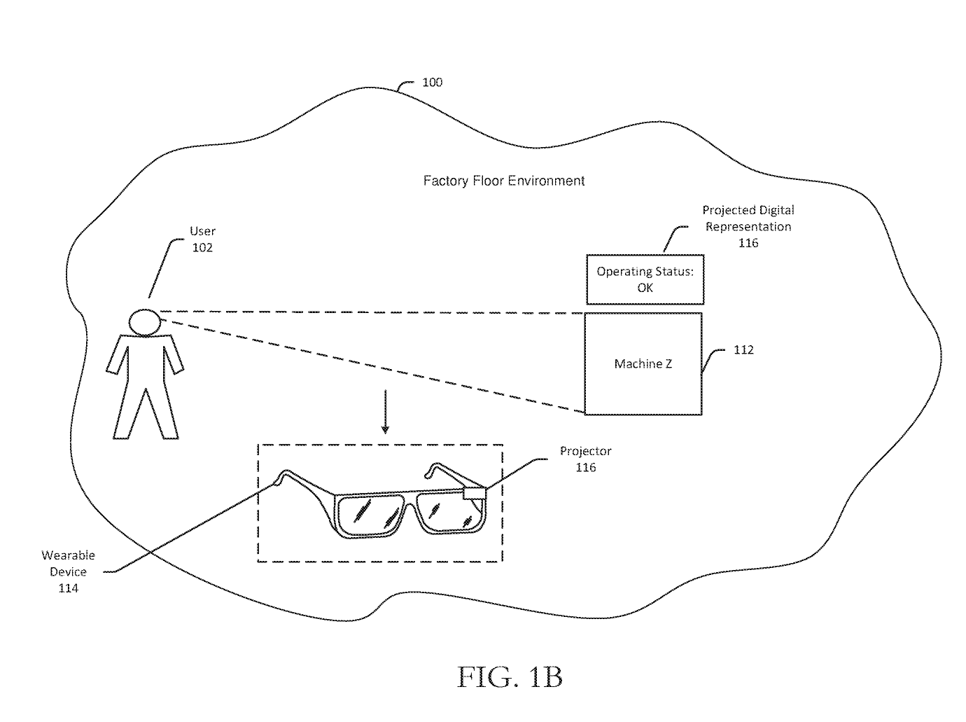

FIG. 1A is a schematic diagram illustrating the use of a computer-mediated-reality-based technology to render digital information relating to a machine or a process involving the machine as an overlay on a display of a wearable device in accordance with one or more example embodiments of the disclosure. An example factory floor environment 100 is depicted in FIG. 1A. The factory floor environment 100 may include any number of varying machines, machine components, or the like. For example, the factory floor environment 100 may include Machine A 104. Any number of processes may be implemented within the factory floor environment 100, where any such process may involve one or more machines within the environment 100.

In certain example embodiments, a user 102, such as a machine operator, may be present within the factory floor environment 100. In conventional factory environments, an operator typically accesses machine/process-specific information using a user device such as a desktop or laptop computer, a tablet, a smartphone, or the like. More specifically, in conventional factory environments, an operator typically utilizes one or more remote terminals to access multiple information systems potentially via multiple software applications. This conventional information retrieval process is time-consuming and prone to error if, for example, the various information systems are not well-integrated, potentially causing an operator to not match the physical machine correctly with the digital data.

Example embodiments of the disclosure eliminate the need for the user 102 to utilize a remote computer or terminal to access machine/process-specific information while present in the factory floor environment 100 by utilizing a computer-mediated-reality-based technology to identify the machine/process-specific information and render a digital representation of the information on top of or otherwise in proximity to a corresponding machine. In this manner, physical machines serve as proxies to available digital information that is relevant to their operation and/or to processes involving such machines. In particular, a physical machine serves as a gateway to identifying digital information relating thereto such that the information can be rendered as a virtual overlay superimposed on a real-world view of the machine within the factory floor environment 100.

FIG. 1A depicts an example embodiment in which the digital information is rendered as an overlay 108 on a display of a wearable device 106. The wearable device 106 may be, for example, a head-mounted device that includes a display that is transparent to the real-world environment. The display may be configured to render a computer-generated image on the display as an overlay over the real-world environment. More specifically, in example embodiments of the disclosure, a digital representation of information relating to Machine A 104 may be generated and rendered as an overlay 108 on the display of the wearable device 106. The overlay 108 may be rendered on the display of the wearable device 106 on top of or in proximity to the real-world view 110 of Machine A through the display of the wearable device 106. In this manner, the user 102 is provided with access to information that is pertinent to the operation of Machine A 104 (or a process involving Machine A 104) in real-time as the user 102 interacts with Machine A 104 within the factory floor environment 100 without the need to utilize a separate remote terminal. Moreover, the information is rendered on top of or in proximity to the user's 102 real-world view of Machine A 104 providing a clear association between the information and the machine to which it pertains.

FIG. 1B is a schematic diagram illustrating the use of a computer-mediated-reality-based technology to render digital information relating to a machine or a process involving the machine as a projection on top of or in proximity to the machine in accordance with one or more example embodiments of the disclosure. FIG. 1B again depicts the factory floor environment of

FIG. 1A. The user 102 is depicted as interacting with a different machine (Machine Z 112) within the factory floor environment 100. In the example embodiment depicted in FIG. 1B, information relating to Machine Z 112 (or a process involving Machine Z 112) may be retrieved and a digital representation 116 thereof may be generated. The digital representation 116 may then be projected onto a surface that is in proximity to Machine Z 112 via one or more projectors 116 of a wearable device 114 utilized by the user 102. The wearable device 114 may employ, for example, a projection-based augmented reality technology to project the digital representation 116 onto a surface of Machine Z 112 itself or a surface that is in close proximity to Machine Z 112. In certain example embodiments, the wearable device 106 and the wearable device 114 may be the same device having the capability to both render the digital representation 116 as the overlay 108 on the display of the wearable device as well as project the digital representation 116 onto a surface present within the factory floor environment 100.

In certain example embodiments, the generation and rendering of the digital representation in the use case of FIG. 1A and/or the use case of FIG. 1B may be initiated responsive, at least in part, to receipt of user input indicative of a selection of a particular machine within the factory floor environment 100. The user input may take the form of a user gesture towards a particular machine such as, for example, the user 102 pointing towards the machine. Such a gesture may be detected by sensors in a wearable device utilized by the user 102 (e.g., the wearable device 106, the wearable device 114) and/or by sensors present in the factory floor environment 100. Alternatively, the user input may be received via direct interaction between the user 102 and the machine such as, for example, by providing touch input to a touch-sensitive display of the machine, by actuating a physical button on the machine, by providing voice-based input, or the like. In certain example embodiments, the user input indicative of a selection of a particular machine may be received as a result of the user 102 directing a line-of-sight (gaze) of a wearable device, such as a head-mounted display, towards the machine.

Upon receiving the user input indicative of a user selection of a particular machine, an object recognition algorithm may be executed to identify the machine. For example, a back-end server may receive the user input indicative of a user selection of a machine and execute the object recognition algorithm to identify the type of machine or the particular machine itself. In certain example embodiments, the user 102 may not be required to provide any separate user input but may simply direct the wearable device towards the selected machine such that the machine is in the field-of-view of the transparent display of the wearable device. The wearable device may then capture an image of the real-world view visible through the display and send the captured image to a back-end server for object recognition processing.

In addition to, or as an alternative to, virtual overlays rendered within a real-world factory environment, a digital representation of information relating to a machine or process may be rendered within a control room environment in certain example embodiments of the disclosure. For example, digital representations may be rendered as overlays on an image of the factory floor environment that is being displayed in a control room environment. In other example embodiments, a complete virtual representation of the factory floor environment may be generated and rendered on a display in a control room environment. Virtual overlays containing machine/process-specific information may then be superimposed on the virtual representation of the factory floor environment.

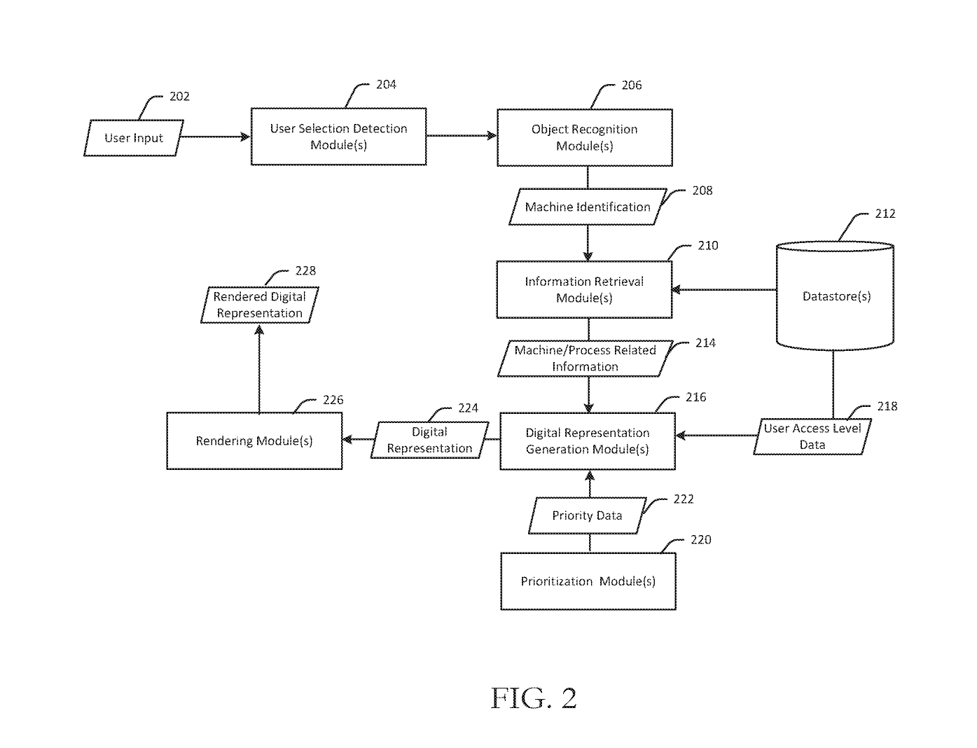

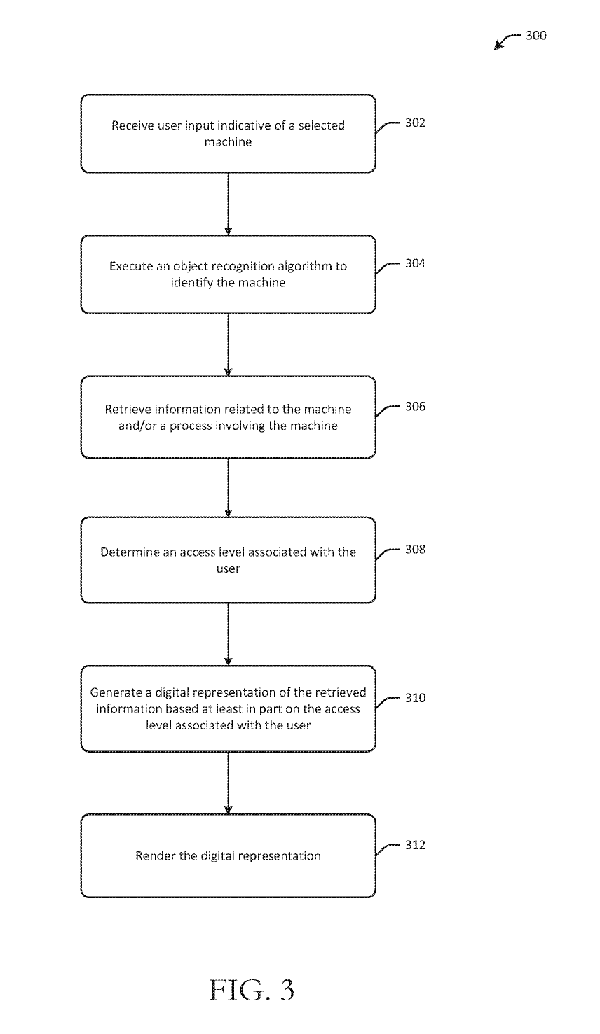

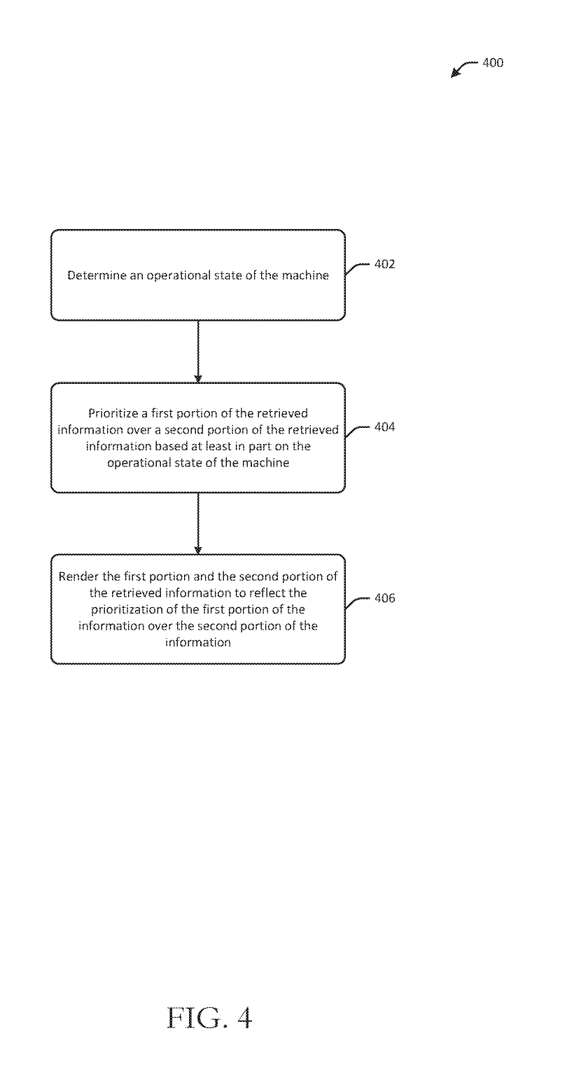

FIG. 2 is a hybrid system component/data flow diagram illustrating the generation and rendering of a digital representation of information relating to a machine or a process involving the machine using a computer-mediated-reality-based technology in accordance with one or more example embodiments of the disclosure. FIG. 3 is a process flow diagram of an illustrative method 300 for generating and rendering a digital representation of information relating to a machine or a process involving the machine using a computer-mediated-reality-based technology in accordance with one or more example embodiments of the disclosure. FIG. 4 is a process flow diagram of an illustrative method 400 for prioritizing information relating to a machine or a process involving the machine and rendering a digital representation of the information that reflects the prioritization in accordance with one or more example embodiments of the disclosure. Each of FIGS. 3 and 4 will be described in conjunction with FIG. 2 hereinafter.

Each operation of either of the methods 300 or 400 may be performed by one or more components that may be implemented in any combination of hardware, software, and/or firmware. In certain example embodiments, one or more of these component(s) may be implemented, at least in part, as software and/or firmware that contains or is a collection of one or more program modules that include computer-executable instructions that when executed by a processing circuit cause one or more operations to be performed. A system or device described herein as being configured to implement example embodiments of the invention may include one or more processing circuits, each of which may include one or more processing units or nodes. Computer-executable instructions may include computer-executable program code that when executed by a processing unit may cause input data contained in or referenced by the computer-executable program code to be accessed and processed to yield output data.

Referring first to FIG. 2 in conjunction with FIG. 3, at block 302 of the method 300, computer-executable instructions of one or more user selection detection modules 204 may be executed to receive user input 202 and process the user input 202 to determine that it is indicative of a user selection of particular machine. The user input 202 may take the form of a user gesture towards a particular machine. Such a gesture may be detected by sensors in a wearable device utilized by a user and/or by sensors present in a factory floor environment. Alternatively, the user input may be received via direct interaction between a user and the machine such as, for example, by providing touch input to a touch-sensitive display of the machine, by actuating a physical button on the machine, by providing voice-based input, or the like.

In certain example embodiments, the user input 202 indicative of a selection of a particular machine may be received as a result of a user directing a line-of-sight (gaze) of a wearable device, such as a head-mounted display, towards the machine. In yet other example embodiments, the user input 202 may be automatically generated as a result of a proximity sensor detecting user presence within a threshold distance of a particular machine. A wearable device and/or a machine within the factory floor environment may contain the proximity sensor. Alternatively, or additionally, a proximity sensor may be provided within the factory floor environment but not as part of any particular machine. It should be appreciated that, in certain example embodiments, a user selection of a particular machine may not be required to initiate processes described herein for rendering digital information in proximity to the machine using a computer-mediated-reality-based technology. Rather, such information may be rendered in connection with all (or some subset thereof) of machines in the factory floor environment on a continuous or periodic basis without the need for user selection of a particular machine. In such example embodiments, a user may nonetheless be able to control what information is rendered. For example, a user may be provided with the capability to cease the rendering of digital information for a machine if so desired. Further, in other example embodiments, the digital information may be rendered on top of or otherwise in proximity to a particular machine if, for example, an alarm or error condition is detected for the machine.

Upon receiving the user input 202 indicative of a user selection of a particular machine, one or more object recognition modules 206 may execute an object recognition algorithm at block 304 of the method 300 to identify the selected machine. For example, a back-end server may receive the user input 202 indicative of a user selection of a machine and execute the object recognition algorithm to identify the type of machine or the particular machine itself. For example, in certain example embodiments, a user may direct the wearable device towards the selected machine such that the machine is visible through the transparent display of the wearable device. The wearable device may then capture an image of the real-world view visible through the display and send the captured image to a back-end server for object recognition processing.

After object recognition is performed to identify the selected machine, an identification 208 of the recognized machine may be provided to one or more information retrieval modules 210. The machine identification 208 may be, for example, an identifier that identifies the type of machine or that uniquely identifies the particular machine itself. Computer-executable instructions of the information retrieval module(s) 210 may be executed at block 306 of the method 300 to retrieve, from one or more datastores 212, information 214 that is relevant to the selected machine or a process involving the selected machine and potentially one or more other machine. The machine/process related information 214 that is retrieved may include, without limitation, real-time operational data for the machine and/or a process involving the machine; cost data; repair data; data identifying error or alarm conditions associated with the machine's operation; power consumption data; and so forth. The information retrieval module(s) 210 may provide the retrieved information 214 as input to one or more digital representation generation modules 216.

At block 308 of the method 300, computer-executable instructions of the digital representation generation module(s) 216 may be executed to determine an access level associated with the user. More specifically, the digital representation generation module(s) 216 may access the datastore(s) 212 using a user identifier or the like to retrieve user access level data 218 indicative of an access level associated with the user. In certain example embodiments, the user identifier may be received from a wearable device to which the identifier is linked. In other example embodiments, the user identifier may be obtained via another mechanism such as from a key card, key fob, or the like that the user used to gain access to the factory floor environment.

At block 310 of the method 300, computer-executable instructions of the digital representation generation module(s) 216 may be executed to generate a digital representation 224 of the retrieved information 214 based at least in part on an access level of the user as indicated by the user access level data 218. The digital representation generation module(s) 216 may provide the digital representation 224 as input to one or more rendering modules 226. In certain example embodiments, the access level of the user may allow the user to access all of the retrieved information 214. In such example embodiments, the digital representation 224 may contain any of the retrieved information 214. In other example embodiments, the user may have a more restrictive level of access. For example, different levels of access may be associated with different user roles (e.g., a manager vs. a service technician). In such example embodiments, some portion of the retrieved information 214 may be excluded from the digital representation 224 so as not to provide the user with information that the user is not permitted to view based on her level of access.

At block 312 of the method 300, computer-executable instructions of the rendering module(s) 226 may be executed to render the digital representation 224. The rendered digital representation 228 may take the form of an overlay that is rendered on a display of a wearable device that is transparent to a real-world environment. In other example embodiments, the rendered digital representation 228 may be a projection of the digital representation 224 onto a surface of the machine or a surface that is proximity to the machine. In still other example embodiments, the rendered digital representation 228 may be an overlay that is superimposed on an image of the factory floor environment being displayed on a control room environmental display or a virtual overlay on a virtual representation of the factory floor environment. In any of the use cases described above, a factory floor operator or a control room operator is provided with real-time information about a machine or process involving the machine, where such information is rendered on top of or otherwise in close proximity to the machine itself, thereby reducing the amount of time that was necessary to access such information using conventional information retrieval systems and allowing the operator to make time-critical, on-the-spot decisions on the factory floor. In addition, example embodiments of the disclosure eliminate information retrieval errors such as data/machine mismatches that occur in connection with conventional information retrieval systems utilized in factory floor environments.

In certain example embodiments, information contained in the digital representation 224 may be prioritized based on various criteria and the digital representation 224 may be rendered in a manner that reflects this prioritization. Referring now to FIG. 4 in conjunction with FIG. 2, at block 402 of the method 400, computer-executable instructions of one or more prioritization module(s) 220 may be executed to determine an operational state of a machine. The operational state of the machine may be determined from the retrieved information 214.

At block 404 of the method 400, computer-executable instructions of the prioritization module(s) 220 may be executed to prioritize a first portion of the retrieved information 214 over a second portion of the retrieved information 214 based at least in part on the operational state of the machine. For example, information identifying operational parameters of the machine (e.g., power consumption, efficiency, temperature data, etc.) may be prioritized over information indicating a number of components processed by the machine per unit time. As another non-limiting example, information indicative of an alarm or error condition associated with the machine may be prioritized above all other information. It should be appreciated that while an operational state of the machine is described as an example basis for prioritization, any other criteria may be used. For example, the access level of the user may be used to prioritize information within the digital representation 224.

The prioritization module(s) 220 may generate priority data 222 indicative of the prioritization determined at block 404 and provide the priority data 222 to the digital representation generation module(s) 216. The digital representation generation module(s) 216 may utilize the priority data 222, at least in part, to generate the digital representation 224. At block 406 of the method 400, computer-executable instructions of the rendering module(s) 226 may be executed to render the digital representation in a manner that reflects the prioritization indicated by the priority data 222. For example, that portion of the information deemed to have the highest priority may be most prominently displayed (e.g., larger font, bolded, etc.) as compared to information deemed to have a lesser priority. In certain example embodiments, information that is deemed to have a priority level below a threshold value, may be excluded entirely from the rendered digital representation 228. In certain example embodiments, the prioritization module(s) 220 may provide the priority data 22 directly to the rendering module(s) 226, which may adjust the rendering of the digital representation 224 to reflect the prioritization indicated by the priority data 222.

One or more illustrative embodiments of the disclosure have been described above. The above-described embodiments are merely illustrative of the scope of this disclosure and are not intended to be limiting in any way. Accordingly, variations, modifications, and equivalents of embodiments disclosed herein are also within the scope of this disclosure. The above-described embodiments and additional and/or alternative embodiments of the disclosure will be described in detail hereinafter through reference to the accompanying drawings.

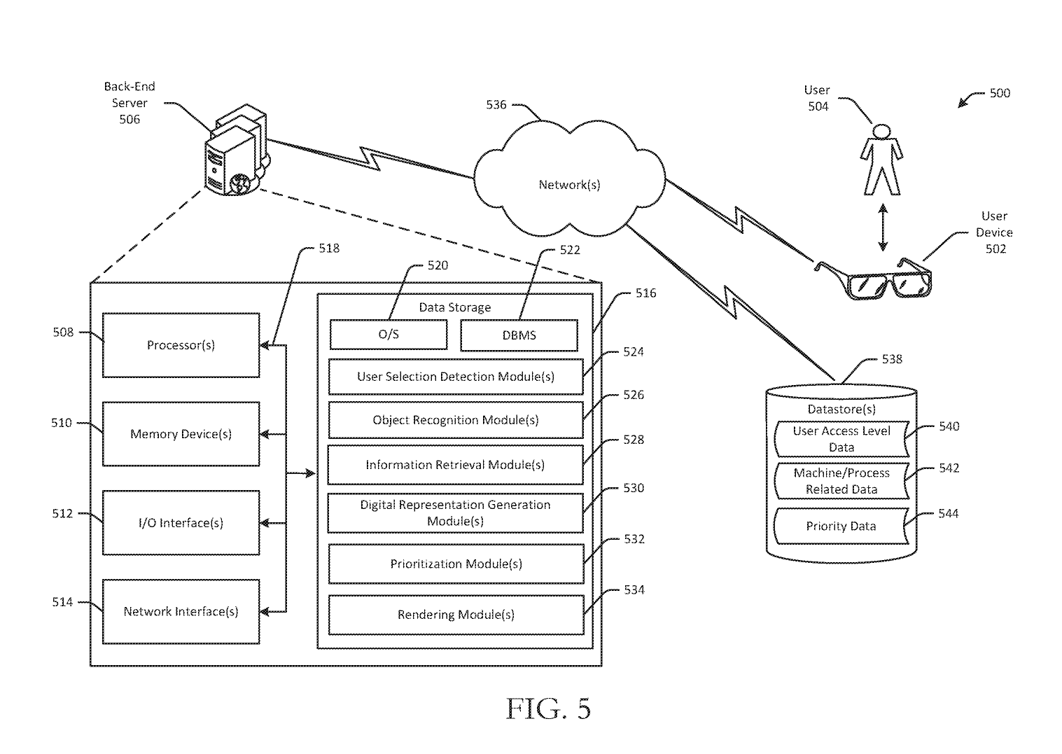

FIG. 5 is a schematic diagram of an illustrative networked architecture 500 in accordance with one or more example embodiments of the disclosure. The networked architecture 500 may include one or more user devices 502, each of which may be utilized by a corresponding user 504. The networked architecture 500 may further include one or more back-end servers 506 and one or more datastores 538. The user device 502 may be, for example, a wearable device such as the wearable device 106 depicted in FIG. 1A or the wearable device 114 depicted in FIG. 1B. In certain example embodiments, the user device 502 may be an augmented reality-enabled contact lens or bionic eye. While multiple user devices 502 and/or multiple back-end servers 506 may form part of the networked architecture 500, these components will be described in the singular hereinafter for ease of explanation. However, it should be appreciated that any functionality described in connection with the back-end server 506 may be distributed among multiple back-end servers 506. Similarly, any functionality described in connection with the user device 502 may be distributed among multiple user devices 502 and/or between a user device 502 and one or more back-end servers 506.

The user device 502 and the back-end server 506 may be configured to communicate via one or more networks 536 which may include, but are not limited to, any one or more different types of communications networks such as, for example, cable networks, public networks (e.g., the Internet), private networks (e.g., frame-relay networks), wireless networks, cellular networks, telephone networks (e.g., a public switched telephone network), or any other suitable private or public packet-switched or circuit-switched networks. Further, the network(s) 536 may have any suitable communication range associated therewith and may include, for example, global networks (e.g., the Internet), metropolitan area networks (MANs), wide area networks (WANs), local area networks (LANs), or personal area networks (PANs). In addition, the network(s) 536 may include communication links and associated networking devices (e.g., link-layer switches, routers, etc.) for transmitting network traffic over any suitable type of medium including, but not limited to, coaxial cable, twisted-pair wire (e.g., twisted-pair copper wire), optical fiber, a hybrid fiber-coaxial (HFC) medium, a microwave medium, a radio frequency communication medium, a satellite communication medium, or any combination thereof.

In an illustrative configuration, the back-end server 506 may include one or more processors (processor(s)) 508, one or more memory devices 510 (generically referred to herein as memory 510), one or more input/output (“I/O”) interface(s) 512, one or more network interfaces 514, and data storage 516. The back-end server 506 may further include one or more buses 518 that functionally couple various components of the server 506. These various components will be described in more detail hereinafter.

The bus(es) 518 may include at least one of a system bus, a memory bus, an address bus, or a message bus, and may permit exchange of information (e.g., data (including computer-executable code), signaling, etc.) between various components of the server 506. The bus(es) 518 may include, without limitation, a memory bus or a memory controller, a peripheral bus, an accelerated graphics port, and so forth. The bus(es) 518 may be associated with any suitable bus architecture including, without limitation, an Industry Standard Architecture (ISA), a Micro Channel Architecture (MCA), an Enhanced ISA (EISA), a Video Electronics Standards Association (VESA) architecture, an Accelerated Graphics Port (AGP) architecture, a Peripheral Component Interconnects (PCI) architecture, a PCI-Express architecture, a Personal Computer Memory Card International Association (PCMCIA) architecture, a Universal Serial Bus (USB) architecture, and so forth.

The memory 510 of the server 506 may include volatile memory (memory that maintains its state when supplied with power) such as random access memory (RAM) and/or non-volatile memory (memory that maintains its state even when not supplied with power) such as read-only memory (ROM), flash memory, ferroelectric RAM (FRAM), and so forth. Persistent data storage, as that term is used herein, may include non-volatile memory. In certain example embodiments, volatile memory may enable faster read/write access than non-volatile memory. However, in certain other example embodiments, certain types of non-volatile memory (e.g., FRAM) may enable faster read/write access than certain types of volatile memory.

In various implementations, the memory 510 may include multiple different types of memory such as various types of static random access memory (SRAM), various types of dynamic random access memory (DRAM), various types of unalterable ROM, and/or writeable variants of ROM such as electrically erasable programmable read-only memory (EEPROM), flash memory, and so forth. The memory 510 may include main memory as well as various forms of cache memory such as instruction cache(s), data cache(s), translation lookaside buffer(s) (TLBs), and so forth. Further, cache memory such as a data cache may be a multi-level cache organized as a hierarchy of one or more cache levels (L1, L2, etc.).

The data storage 516 may include removable storage and/or non-removable storage including, but not limited to, magnetic storage, optical disk storage, and/or tape storage. The data storage 516 may provide non-volatile storage of computer-executable instructions and other data. The memory 510 and the data storage 516, removable and/or non-removable, are examples of computer-readable storage media (CRSM) as that term is used herein.

The data storage 516 may store computer-executable code, instructions, or the like that may be loadable into the memory 510 and executable by the processor(s) 508 to cause the processor(s) 508 to perform or initiate various operations. The data storage 516 may additionally store data that may be copied to memory 510 for use by the processor(s) 508 during the execution of the computer-executable instructions. Moreover, output data generated as a result of execution of the computer-executable instructions by the processor(s) 508 may be stored initially in memory 510, and may ultimately be copied to data storage 516 for non-volatile storage.

More specifically, the data storage 516 may store one or more operating systems (O/S) 520; one or more database management systems (DBMS) 522; and one or more program modules, applications, engines, computer-executable code, scripts, or the like such as, for example, one or more user selection detection modules 524, one or more object recognition modules 526, one or more information retrieval modules 528, one or more digital representation generation module(s) 530, and one or more prioritization modules 532, and one or more rendering modules 534. One or more of these program modules may include one or more sub-modules. Any of the components depicted as being stored in data storage 516 may include any combination of software, firmware, and/or hardware. The software and/or firmware may include computer-executable code, instructions, or the like that may be loaded into the memory 510 for execution by one or more of the processor(s) 508 to perform any of the operations described earlier in connection with correspondingly named modules.

The data storage 516 may further store various types of data utilized by components of the server 506 such as, for example, any of the data depicted as being stored in the data store(s) 538. Any data stored in the data storage 516 may be loaded into the memory 510 for use by the processor(s) 508 in executing computer-executable code. In addition, any data stored in the data store(s) 538 may be accessed via the DBMS 522 and loaded in the memory 510 for use by the processor(s) 508 in executing computer-executable code.

The processor(s) 508 may be configured to access the memory 510 and execute computer-executable instructions loaded therein. For example, the processor(s) 508 may be configured to execute computer-executable instructions of the various program modules, applications, engines, or the like of the server 506 to cause or facilitate various operations to be performed in accordance with one or more embodiments of the disclosure. The processor(s) 508 may include any suitable processing unit capable of accepting data as input, processing the input data in accordance with stored computer-executable instructions, and generating output data. The processor(s) 508 may include any type of suitable processing unit including, but not limited to, a central processing unit, a microprocessor, a Reduced Instruction Set Computer (RISC) microprocessor, a Complex Instruction Set Computer (CISC) microprocessor, a microcontroller, an Application Specific Integrated Circuit (ASIC), a Field-Programmable Gate Array (FPGA), a System-on-a-Chip (SoC), a digital signal processor (DSP), and so forth. Further, the processor(s) 508 may have any suitable microarchitecture design that includes any number of constituent components such as, for example, registers, multiplexers, arithmetic logic units, cache controllers for controlling read/write operations to cache memory, branch predictors, or the like. The microarchitecture design of the processor(s) 508 may be capable of supporting any of a variety of instruction sets.

Referring now to other illustrative components depicted as being stored in the data storage 516, the 0/5 520 may be loaded from the data storage 516 into the memory 510 and may provide an interface between other application software executing on the server 506 and hardware resources of the server 506. More specifically, the 0/5 520 may include a set of computer-executable instructions for managing hardware resources of the server 506 and for providing common services to other application programs (e.g., managing memory allocation among various application programs). In certain example embodiments, the O/S 520 may control execution of one or more of the program modules depicted as being stored in the data storage 516. The O/S 520 may include any operating system now known or which may be developed in the future including, but not limited to, any server operating system, any mainframe operating system, or any other proprietary or non-proprietary operating system.

The DBMS 522 may be loaded into the memory 510 and may support functionality for accessing, retrieving, storing, and/or manipulating data stored in the memory 510, data stored in the datastore(s) 538, and/or data stored in the data storage 516. The DBMS 522 may use any of a variety of database models (e.g., relational model, object model, etc.) and may support any of a variety of query languages. The DBMS 522 may access data represented in one or more data schemas and stored in any suitable data repository.

The data store(s) 538 may include, but are not limited to, databases (e.g., relational, object-oriented, etc.), file systems, flat files, distributed datastores in which data is stored on more than one node of a computer network, peer-to-peer network datastores, or the like. The data store(s) 538 may store various types of data such as, for example, user access level data 540 (which may include the user access level data 218 depicted in FIG. 2); machine/process related data 542 (which may include the machine/process related information depicted in FIG. 2); and priority data 544 (which may include the priority data 222 depicted in FIG. 2).

Referring now to other illustrative components of the server 506, the input/output (I/O) interface(s) 512 may facilitate the receipt of input information by the server 506 from one or more I/O devices as well as the output of information from the server 506 to the one or more I/O devices. The I/O devices may include any of a variety of components such as a display or display screen having a touch surface or touchscreen; an audio output device for producing sound, such as a speaker; an audio capture device, such as a microphone; an image and/or video capture device, such as a camera; a haptic unit; and so forth. Any of these components may be integrated into the server 506 or may be separate. The I/O devices may further include, for example, any number of peripheral devices such as data storage devices, printing devices, and so forth.

The I/O interface(s) 512 may also include an interface for an external peripheral device connection such as universal serial bus (USB), FireWire, Thunderbolt, Ethernet port or other connection protocol that may connect to one or more networks. The I/O interface(s) 512 may also include a connection to one or more antennas to connect to one or more networks via a wireless local area network (WLAN) (such as Wi-Fi) radio, Bluetooth, and/or a wireless network radio, such as a radio capable of communication with a wireless communication network such as a Long Term Evolution (LTE) network, WiMAX network, 3G network, etc.

The server 506 may further include one or more network interfaces 514 via which the server 506 may communicate with any of a variety of other systems, platforms, networks, devices, and so forth. The network interface(s) 514 may enable communication, for example, with the user device 502 and/or the data store(s) 538 via the network(s) 546.

Referring now to the user device 502, in an illustrative configuration, the user device may include similar hardware and/or software components as those depicted in connection with the illustrative configuration of the server 506. In certain example embodiments, the user device 502 may be a wearable device that includes a display that is transparent to a real-world environment and on which computer-generated images can be rendered as overlays over the real-world environment. In certain example embodiments, the user device 502 may be a wearable device that includes one or more projectors configured to project computer-generated images onto a surface such as the surface of a machine within a factory floor environment or any other suitable surface that is in proximity to the machine. In certain example embodiments, the user device 502 may render virtual overlays that are capable of being manipulated by the user within the real-world environment in connection with a mixed-reality technology. In yet other example embodiments, the user device 502 may employ a virtual reality technology to generate a completely virtual representation of the factory floor environment. It should be appreciated that the above examples are merely illustrative and not exhaustive.

The user device 502 may further include one or more antennas that may include, without limitation, a cellular antenna for transmitting or receiving signals to/from a cellular network infrastructure, an antenna for transmitting or receiving Wi-Fi signals to/from an access point (AP), a GNSS antenna for receiving GNSS signals from a GNSS satellite, a Bluetooth antenna for transmitting or receiving Bluetooth signals, a Near Field Communication (NFC) antenna for transmitting or receiving NFC signals, and so forth. The antenna(s) may include any suitable type of antenna depending, for example, on the communications protocols used to transmit or receive signals via the antenna(s). Non-limiting examples of suitable antennas may include directional antennas, non-directional antennas, dipole antennas, folded dipole antennas, patch antennas, multiple-input multiple-output (MIMO) antennas, or the like. The antenna(s) may be communicatively coupled to one or more radio components to which or from which signals may be transmitted or received.

The radio(s) may include any suitable radio component(s) for—in cooperation with the antenna(s)—transmitting or receiving radio frequency (RF) signals in the bandwidth and/or channels corresponding to the communications protocols utilized by the user device 502 to communicate with other devices. The radio(s) may include hardware, software, and/or firmware for modulating, transmitting, or receiving—potentially in cooperation with any of antenna(s)—communications signals according to any of the communications protocols discussed above including, but not limited to, one or more Bluetooth communication protocols, one or more Wi-Fi and/or Wi-Fi direct protocols, as standardized by the IEEE 802.11 standards, one or more non-Wi-Fi protocols, or one or more cellular communications protocols or standards. The radio(s) may further include hardware, firmware, or software for receiving GNSS signals. The radio(s) may include any known receiver and baseband suitable for communicating via the communications protocols utilized by the user device 502. The radio(s) may further include a low noise amplifier (LNA), additional signal amplifiers, an analog-to-digital (A/D) converter, one or more buffers, a digital baseband, or the like.

The user device 502 may further include one or more sensors/sensor interfaces that may include or may be capable of interfacing with any suitable type of sensing device such as, for example, inertial sensors, force sensors, thermal sensors, optical sensors, time-of-flight sensors, and so forth. Example types of inertial sensors may include accelerometers (e.g., MEMS-based accelerometers), gyroscopes, and so forth.

It should be appreciated that the program modules, applications, computer-executable instructions, code, or the like depicted in FIG. 5 as being stored in the data storage 516 are merely illustrative and not exhaustive and that processing described as being supported by any particular module may alternatively be distributed across multiple modules or performed by a different module. In addition, various program module(s), script(s), plug-in(s), Application Programming Interface(s) (API(s)), or any other suitable computer-executable code hosted locally on the server 506, the user device 502, and/or hosted on other computing device(s) accessible via one or more of the network(s) 546, may be provided to support functionality provided by the program modules, applications, or computer-executable code depicted in FIG. 5 and/or additional or alternate functionality. Further, functionality may be modularized differently such that processing described as being supported collectively by the collection of program modules depicted in FIG. 5 may be performed by a fewer or greater number of modules, or functionality described as being supported by any particular module may be supported, at least in part, by another module. In addition, program modules that support the functionality described herein may form part of one or more applications executable across any number of systems or devices in accordance with any suitable computing model such as, for example, a client-server model, a peer-to-peer model, and so forth. In addition, any of the functionality described as being supported by any of the program modules depicted in FIG. 5 may be implemented, at least partially, in hardware and/or firmware across any number of devices.

It should further be appreciated that the server 506 and/or the user device 502 may include alternate and/or additional hardware, software, or firmware components beyond those described or depicted without departing from the scope of the disclosure. More particularly, it should be appreciated that software, firmware, or hardware components depicted as forming part of the server 506 and/or the user device 502 are merely illustrative and that some components may not be present or additional components may be provided in various embodiments. While various illustrative program modules have been depicted and described as software modules stored in data storage 516, it should be appreciated that functionality described as being supported by the program modules may be enabled by any combination of hardware, software, and/or firmware. It should further be appreciated that each of the above-mentioned modules may, in various embodiments, represent a logical partitioning of supported functionality. This logical partitioning is depicted for ease of explanation of the functionality and may not be representative of the structure of software, hardware, and/or firmware for implementing the functionality. Accordingly, it should be appreciated that functionality described as being provided by a particular module may, in various embodiments, be provided at least in part by one or more other modules. Further, one or more depicted modules may not be present in certain embodiments, while in other embodiments, additional modules not depicted may be present and may support at least a portion of the described functionality and/or additional functionality. Moreover, while certain modules may be depicted and described as sub-modules of another module, in certain embodiments, such modules may be provided as independent modules or as sub-modules of other modules.

One or more operations of any of the methods 200-400 may be performed by a server 506, by a user device 502, or in a distributed fashion by a server 506 and a user device 502 having the illustrative configuration depicted in FIG. 5, or more specifically, by one or more engines, program modules, applications, or the like executable on such device(s). It should be appreciated, however, that such operations may be implemented in connection with numerous other device configurations.

The operations described and depicted in the illustrative methods of FIGS. 2-4 may be carried out or performed in any suitable order as desired in various example embodiments of the disclosure. Additionally, in certain example embodiments, at least a portion of the operations may be carried out in parallel. Furthermore, in certain example embodiments, less, more, or different operations than those depicted in FIGS. 2-4 may be performed.

Although specific embodiments of the disclosure have been described, one of ordinary skill in the art will recognize that numerous other modifications and alternative embodiments are within the scope of the disclosure. For example, any of the functionality and/or processing capabilities described with respect to a particular device or component may be performed by any other device or component. Further, while various illustrative implementations and architectures have been described in accordance with embodiments of the disclosure, one of ordinary skill in the art will appreciate that numerous other modifications to the illustrative implementations and architectures described herein are also within the scope of this disclosure. In addition, it should be appreciated that any operation, element, component, data, or the like described herein as being based on another operation, element, component, data, or the like can be additionally based on one or more other operations, elements, components, data, or the like. Accordingly, the phrase “based on,” or variants thereof, should be interpreted as “based at least in part on.”

Although embodiments have been described in language specific to structural features and/or methodological acts, it is to be understood that the disclosure is not necessarily limited to the specific features or acts described. Rather, the specific features and acts are disclosed as illustrative forms of implementing the embodiments. Conditional language, such as, among others, “can,” “could,” “might,” or “may,” unless specifically stated otherwise, or otherwise understood within the context as used, is generally intended to convey that certain embodiments could include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without user input or prompting, whether these features, elements, and/or steps are included or are to be performed in any particular embodiment.

The present disclosure may be a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

1. A method, comprising:
executing an object recognition algorithm to identify a machine;
obtaining information associated with the machine;
generating a digital representation of the information; and
rendering the digital representation on top of or in proximity to the machine.

2. The method of claim 1, wherein rendering the digital representation on top of or in proximity to the machine comprises rendering the digital representation as an augmented reality or mixed reality overlay on a real-world view of the machine.

3. The method of claim 2, wherein at least one of: i) the overlay is rendered on a display of a wearable device or ii) the overlay is projected onto a surface in the proximity to the machine.

4. The method of claim 1, further comprising:
receiving an indication of a user gesture directed towards the machine,
wherein the digital representation is generated and rendered based at least in part on receiving the indication of the user gesture.

5. The method of claim 1, further comprising:
determining a level of access associated with a user;
determining, based at least in part on the level of access, a portion of the information that the user is not permitted to access; and
excluding the portion of the information from the digital representation.

6. The method of claim 1, further comprising:
determining that an alarm condition is associated with the machine,
wherein generating the digital representation comprises generating the digital representation responsive, at least in part, to determining that the alarm condition is associated with the machine.

7. The method of claim 1, further comprising:
determining an operational state of the machine; and
prioritizing, based at least in part on the operational state of the machine, a first portion of the information over a second portion of the information,
wherein rendering the digital representation comprises rendering the first portion of the information and rendering the second portion of the information to reflect prioritization of the first portion of the information over the second portion of the information.

8. A system, comprising:
at least one memory storing computer-executable instructions; and
at least one processor configured to access the at least one memory and execute the computer-executable instructions to:
execute an object recognition algorithm to identify a machine;
obtain information associated with the machine;
generate a digital representation of the information; and
render the digital representation on top of or in proximity to the machine.

9. The system of claim 8, wherein the at least one processor is configured to render the digital representation on top of or in proximity to the machine by executing the computer-executable instructions to render the digital representation as an augmented reality or mixed reality overlay on a real-world view of the machine.

10. The system of claim 9, further comprising a wearable device comprising a display and a projector, wherein at least one of: i) the overlay is rendered on the display of the wearable device or ii) the overlay is projected, via the projector, onto a surface in the proximity to the machine.

11. The system of claim 8, wherein the at least one processor is further configured to execute the computer-executable instructions to:
receive an indication of a user gesture directed towards the machine,
wherein the digital representation is generated and rendered based at least in part on receiving the indication of the user gesture.

12. The system of claim 8, wherein the at least one processor is further configured to execute the computer-executable instructions to:
determine a level of access associated with a user;
determine, based at least in part on the level of access, a portion of the information that the user is not permitted to access; and
exclude the portion of the information from the digital representation.

13. The system of claim 8, wherein the at least one processor is further configured to execute the computer-executable instructions to:
determine that an alarm condition is associated with the machine,
wherein the at least one processor is configured to generate the digital representation by executing the computer-executable instructions to generate the digital representation responsive, at least in part, to determining that the alarm condition is associated with the machine.

14. The system of claim 8, wherein the at least one processor is further configured to execute the computer-executable instructions to:
determine an operational state of the machine; and
prioritize, based at least in part on the operational state of the machine, a first portion of the information over a second portion of the information,
wherein the at least one processor is configured to render the digital representation by executing the computer-executable instructions to render the first portion of the information and to render the second portion of the information to reflect prioritization of the first portion of the information over the second portion of the information.

15. A computer program product comprising a non-transitory computer-readable storage medium readable by a processing circuit, the storage medium storing instructions executable by the processing circuit to cause a method to be performed, the method comprising:
executing an object recognition algorithm to identify a machine;
obtaining information associated with the machine;
generating a digital representation of the information; and
rendering the digital representation on top of or in proximity to the machine.

16. The computer program product of claim 15, wherein rendering the digital representation on top of or in proximity to the machine comprises rendering the digital representation as an augmented reality or mixed reality overlay on a real-world view of the machine.

17. The computer program product of claim 16, wherein at least one of: i) the overlay is rendered on a display of a wearable device or ii) the overlay is projected onto a surface in the proximity to the machine.

18. The computer program product of claim 15, the method further comprising:
receiving an indication of a user gesture directed towards the machine,
wherein the digital representation is generated and rendered based at least in part on receiving the indication of the user gesture.

19. The computer program product of claim 15, the method further comprising:
determining a level of access associated with a user;
determining, based at least in part on the level of access, a portion of the information that the user is not permitted to access; and
excluding the portion of the information from the digital representation.

20. The computer program product of claim 15, the method further comprising:
determining an operational state of the machine; and
prioritizing, based at least in part on the operational state of the machine, a first portion of the information over a second portion of the information,
wherein rendering the digital representation comprises rendering the first portion of the information and rendering the second portion of the information to reflect prioritization of the first portion of the information over the second portion of the information.
